(19) United States
(12) Patent Application Publication
(10) Pub. No.: US 2009/0139655 A1
(43) Pub. Date: Jun. 4, 2009

(54) Adhesive seal peeling device for a hard disk drive

(76) Inventor: Xiang Yang Feng, Singapore (SG)

Correspondence Address: HITACHI C/O WAGNER BLECHER LLP, 123 WESTRIDGE DRIVE, WATSONVILLE, CA, 95076, US

(21) Appl. No.: 11/998,548

(22) Filed: Nov. 30, 2007

(51) Int. Cl. B32B 38/10; B32B 37/00

(52) U.S. Cl. 156/344; 156/537

(57) ABSTRACT

The present invention provides a system and method for peeling off a adhesive seal for sealing a evacuation hole in the cover of a hard disk drive without damaging the seal in the fabrication and manufacture of hard disk drives.

In one embodiment, a seal peel-off device having a upper presser plate and a lower liner base plate are respectively aligned at the top and bottom of a targeted adhesive seal to be peeled-off from a seal template having a number of adhesive seals and by applying pressure to the upper presser plate of the seal peel-off device, the targeted adhesive seal is removed without any damages.

### TECHNICAL FIELD

The present invention relates generally to a method and a system for manufacturing and fabricating hard drive components in a manufacturing environment, and more particularly, to a sealing device for sealing a contamination evacuation hole in the cover of the hard disk drive.

### BACKGROUND ART

In general, a hard disk drive is used in many processing and computing systems, magnetic data storage devices, such as disk drives are utilized for storing data. A typical disk drive includes a spindle motor having a rotor for rotating one or more data disks having data storage surfaces, and an actuator for moving a head carrier arm that supports transducer (read/write) heads, radially across the data disks to write data to or read data from concentric data tracks on the data disk.

In order to preserve the reliability of the hard disk drive, most hard disk drives are manufactured under “clean room” conditions to prevent the introduction of contaminants to enter the hard disk drive. Once assembled, the hard disk drive remains sealed under normal operating conditions.

Due to the sensitivity of the components of the hard disk drive, especially during the reading and writing of information, it is necessary after the initial cleaning during the manufacturing process to prevent contamination of the hard disk drive during subsequent assembly and testing processes. Upon final assembly, a base and cover for the hard disk drive are assembled and sealed to each other in order to prevent the influx of external contaminates such as dust or moisture. The cover of the hard disk drive also typically has an evacuation hole through which the sealed hard disk drive is further evacuated to remove any additional contaminates that might have entered the hard disk drive during the sealing process. After the final evacuation process, the evacuation hole is sealed with a adhesive sealing material.

In sealing the evacuation hole of a conventional hard disk drive, an operator typically peels-off the adhesive material from a sealing template having multiple sealing material with a device such as a pair of tweezers and affix the seal over the evacuation hole. Such conventional method of sealing the evacuation hole may introduce additional contaminates in the evacuated hard disk drive. In addition to the tweezing process being too time consuming, using the tweezers could also lead to the adhesive edges of the adhesive material being compromised and giving a good seal. This could also lead to further contamination of the hard disk drive.

Therefore, what is need is a flexible way of component fabrication and manufacturing that particulates and other contaminants permits to be controllably dissipated from the materials used in the construction of these components such that the potential damage from electrostatic discharge or electromagnetic interference to electric components connected to such components is reduced and an improved way of an improved process of affixing adhesive seals to the cover of the hard disk drive after the drive assembly process is completed.

### SUMMARY

In accordance with certain aspects of the present invention, there is provided a system and method for peeling off a adhesive seal for sealing a evacuation hole in the cover of a hard disk drive without damaging the seal in the fabrication and manufacture of hard disk drives.

In one embodiment, a seal peel-off device having a upper presser plate and a lower liner base plate are respectively aligned at the top and bottom of a targeted adhesive seal to be peeled-off from a seal template having a number of adhesive seals and by applying pressure to the upper presser plate of the seal peel-off device, the targeted adhesive seal is removed without any damages.

In one embodiment, the upper presser plate includes a suction hole which is designed to be larger than the size of the seals to be peeled off in order to allow for the suction hole to conveniently fit over the targeted adhesive seal without compromising the adhesive edges of the seal as the seal is removed from the seal template.

In one embodiment, the lower base liner plate has a protrusion pin which holds in place the targeted seal in order to allow the presser plate to peel off the targeted seal without leaving any contaminates on the adhesive side of the seal. The protrusion pin is designed to be smaller in size than the size of the targeted seal being peeled off.

### BRIEF DESCRIPTION OF THE DRAWINGS

The accompanying drawings, which are incorporated in and constitute a part of the specification, illustrate embodiments of the invention, and together with the general description given above and the detailed description given below serve to explain the teachings of the invention.

FIG. 1 is a plan view of an HDD in accordance with one embodiment of the present invention.

FIG. 2 is a plan view of the disk drive of one embodiment of the present invention illustrating the relative placement of the evacuation hole in the cover of the hard disk drive utilizing the sealing process of the present invention.

FIG. 3 is a block diagram illustration of one embodiment of the seal peeling device according to one embodiment of the invention.

FIG. 4A is a plan view of one embodiment of the upper plate presser of the sealing device of one embodiment of the present invention.

FIG. 4B is a plan view of one embodiment of the application of the upper plate presser to the seal template according to one embodiment of the present invention.

FIG. 4C is a plan view of one embodiment of the upper plate presser and the seal peel-off according to one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a hard disk drive and components connected therewith. The discussion will then focus on embodiments of a method and system for peeling off a adhesive sealing material during the manufacturing of the hard disk drive in a disk drive assembly environment by providing a peel-off seal device that ensures that the seal does not introduce contaminates into the disk drive and also prevents the seal from being damaged.

### Overview

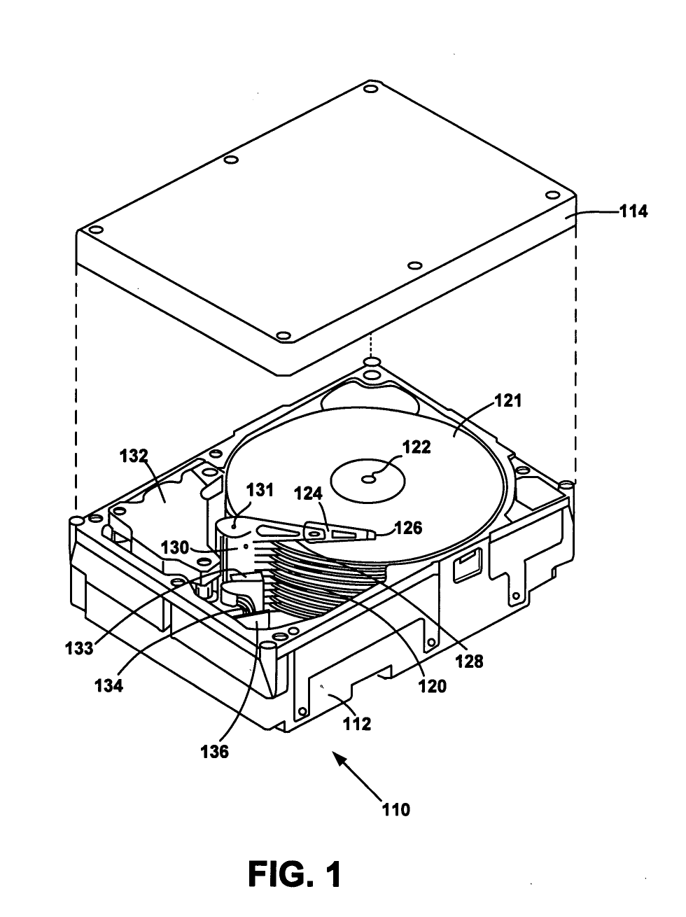

In general, the HDD comb (also referred to as an E-block) serves as a platform on which the suspensions (compliant members containing sliders with recording heads) are mounted. The recording heads fly at a constant height (on the order of nanometers) above the disk surface tracking pre-written servo information. An HDD carriage assembly (as shown in FIG. 1) forms the primary motive mechanical system that enables a disk-drive to randomly access data to be written or recorded on the disk surfaces.

With reference now to FIG. 1 shows a disk drive system designated by the general reference number 100. The cover 114 of the disk drive 100 is shown exploded. In operation, the cover 110 would be disposed on top of the housing 112. The disk drive 100 comprises one or more magnetic disks 121. The disks 121 may be conventional particulate or thin film recording disks, which are capable of storing digital data in concentric tracks. In one embodiment, both sides of the disks 121 are available for storage, and it will be recognized by one of ordinary skill in the art that the disks drive 100 may include any number of such disks 121.

The disks 121 are mounted to a spindle 122. The spindle 122 is attached to a spindle motor which rotates the spindle 122 and the disks 121 to provide read/write access to the various portions of the concentric tracks on the disks 121.

An actuator assembly 130 includes a positioner arm 128 and a suspension assembly 124. The suspension assembly 124 includes a slider assembly 126 at its distal end. Although only one slider assembly 126 is shown, it will be recognized by one skilled in the relevant art the disk drive 100 could have one slider assembly 126 for each positioner arm 128. The positioner arm 128 further comprises a pivot 131 around which the positioner arm 128 pivots.

The disk drive 100 further includes a amplifier chip 133. As is well known in the art, the amplifier chip 133 cooperates with the slider assembly on the slider assembly 126 to read data from or write data to the disks 121. The main function of the actuator assembly 130 is to move the positioner arm 128 around the pivot 131.

During manufacturing of the disk drive 100, particulates such as dust and other accumulate in the housing which need to be evacuated either prior to the sealing of the cover 114 to the housing or after the cover has been sealed to the housing.

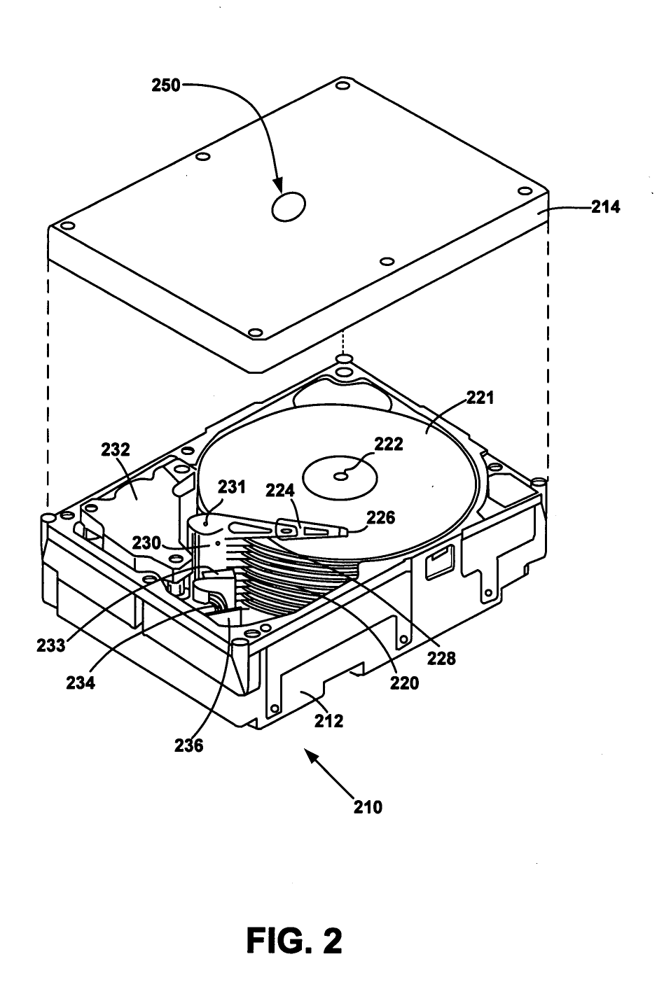

With reference now to FIG. 2 is shown an exemplary plan view of a hard disk drive 200 according to one embodiment of the present invention. As shown in FIG. 2, the cover 214 is exploded to show an evacuation hole 250. In one embodiment of the evacuation hole 250 is enables the sealed hard disk drive 200 (after the cover 214 has been sealed to the housing 212) to be evacuated of any contaminates in the housing 212 post sealing. Evacuating the sealed hard disk drive 200 through evacuation hole 250, enables an operator to evaluate the particulate count in the sealed hard drive to determine whether there are any contaminates in the drive. If there are not any contaminates in the sealed drive, the evacuation hole is sealed with the adhesive sealing material according to the sealing process of the present invention.

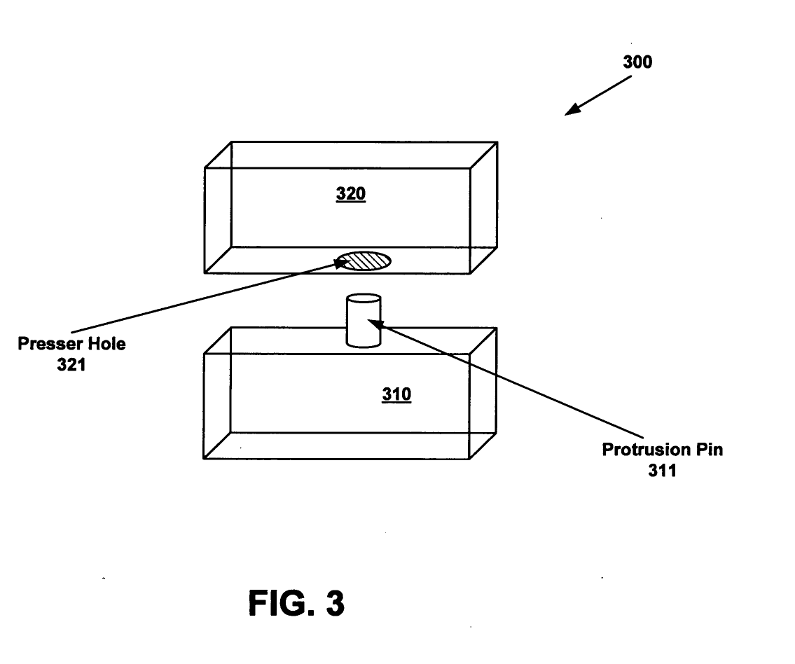

FIG. 3 is an exemplary cross sectional view illustration of one embodiment of the peel-off sealing device according to the present invention. As shown in FIG. 3, the peel-off sealing device 300 comprises a base liner 310 and a upper presser plate 320.

In one embodiment, the base liner 310 includes a retaining protrusion pin 311 which holds the adhesive side of a targeted adhesive seal being peeled off from a adhesive seal material template by the peel-off sealing device 300. In one embodiment of the present invention, the sealing material source template comprises a plurality of adhesive seals utilized by the present invention to seal the evacuation hole 250 in the cover of the hard disk drive. In one embodiment the adhesive seal is designed in such a manner that one side of the seal is adhesive and the opposite side is plastic. In one embodiment, the adhesive side of the seal has a non-adhesive central portion which is attached to the protrusion pin 311 during the peeling-off process. In one embodiment, the retaining protrusion pin 311 is smaller in size than the central non-adhesive portion of the adhesive seal.

The upper presser plate 320 comprises a suction hole 321 which is placed over the targeted adhesive seal being peeled-off (at the plastic side) and when pressed downwards, the suction hole 321 peels-off the targeted seal from the seal template. In one embodiment of the present invention, the upper presser plate 320 is made of a flexible material which when a slight downward pressure is applied to it allows the suction hole 321 to peel-off the targeted seal.

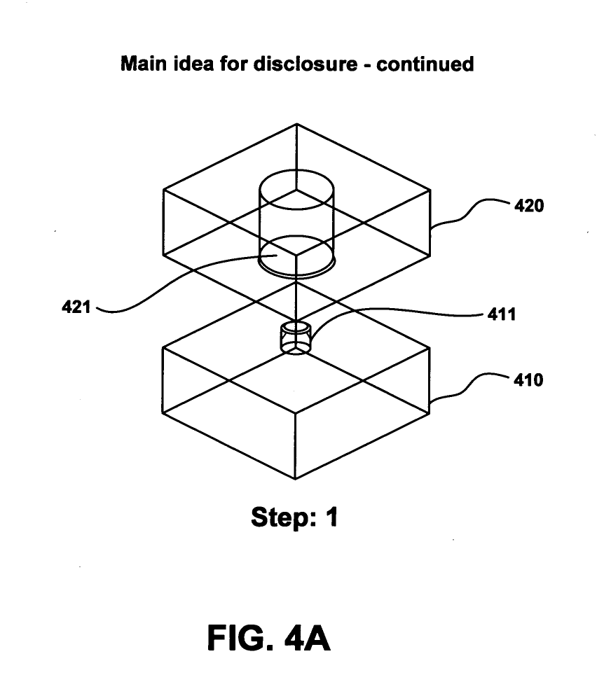

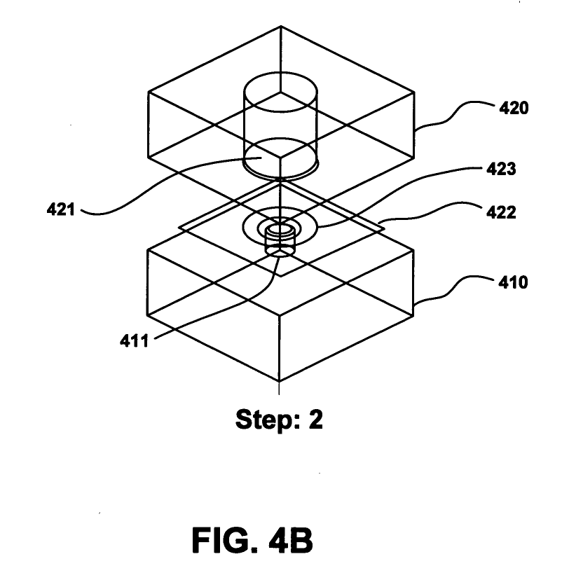

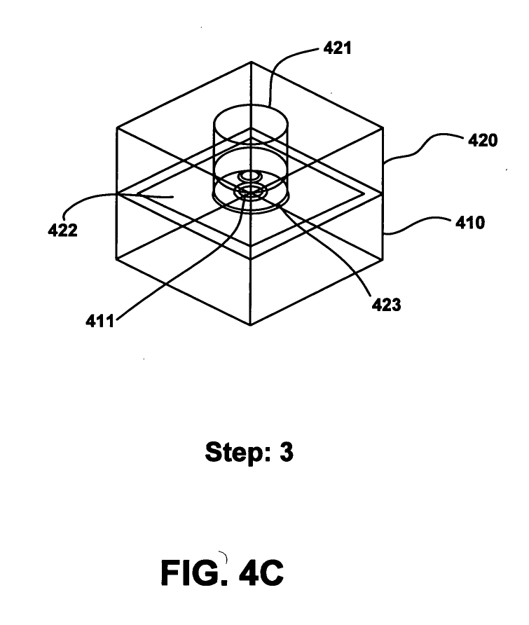

FIGS. 4A-4C a plan view illustration of the application of the seal peel-off device according to the present invention in peeling off a targeted seal from the seal template for affixation to the evacuation hole in the cover of the hard disk drive.

As shown in FIG. 4A, during a first step, the protrusion pin 311 of the base liner plate 310 of the peel-off device is aligned with the non-adhesive central portion of the adhesive side of the seal. In step 2, as shown in FIG. 4B, the seal template is aligned with the protrusion pin 311 and the suction hole in the presser plate 320 is aligned on top of the seal. In step 3 as shown in FIG. 4C, the presser plate 320 is depressed causing the suctioning of the seal from the template and thereby peeling-off the seal from the template. In one embodiment of the present invention, the suctioned seal may be subsequently suction off by a vacuum suction tool from the suction hole 321 and affixed to the evacuation. Using the vacuum suction tool ensures that the peeled-off seal is not comprised along its adhesive edges as the seal is being affixed to the cover of the hard disk drive.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A sealing device for hard disk drives having a base and a cover having an evacuation hole assembled with the base, the sealing device, comprising:
a liner base having a protrusion pin for holding a targeted adhesive sealing material in place to be peeled-off from a seal material source template for sealing the evacuation hole in the cover; and
a extraction top plate presser for removing the targeted adhesive sealing material from the seal material source template prior to affixing the adhesive sealing material to the cover without causing any damage to the adhesive sealing material.

2. The sealing device of claim 1, wherein the extraction top plate presser comprises a extraction head fixably attached to the adhesive seal to extract the adhesive sealing material from the source template without causing damages to the adhesive edges of the adhesive sealing material.

3. The sealing device of claim 2, wherein the extraction head of the upper plate presser is larger in size than the size of the adhesive sealing material.

4. The sealing device of claim 3, wherein the upper plate presser extracts the adhesive sealing material from the source template without touch the adhesive sides of the adhesive sealing material.

5. The sealing device of claim 4, wherein the protrusion pin is smaller in size than the adhesive sealing material.

6. A hard disk drive, comprising
a base plate;
a cover plate with an evacuation hole that requires to be sealed after assembling the base plate and the cover plate; and
a peel-off sealing device for sealing the evacuation hole in the cover plate, the peel-off sealing device, comprising;
a upper portion presser with a seal extraction hole; and
a lower portion base liner with a protrusion pin.

7. The peel-off sealing device of claim 6, wherein the upper portion presser extracts adhesive sealing material from a sealing material source template for affixing to the evacuation hole of the cover plate of the hard disk drive.

8. The peel-off sealing device of claim 7, wherein the protrusion pin in the lower portion base liner holds an extracted adhesive sealing material from sealing material source template in place for extraction by the upper portion presser.

9. The peel-off sealing device of claim 8, wherein the extraction hole in the upper portion presser is larger in diameter than the diameter of the adhesive sealing material in order to prevent the adhesive sealing material from being damaged when extracted from the source template.

10. The peel-off sealing device of claim 9, wherein a vacuum suction tool is utilized to extract the seal material from the extraction hole in the upper portion presser for affixation to the cover plate of the hard disk drive.

11. A method for peeling-off a adhesive seal for sealing a evacuation hole in the cover of a hard disk drive, the method comprising:
providing a seal template of adhesive seals having a plurality of a fixed shaped adhesive seal;
providing a peel-off sealing device having a upper presser unit and a lower liner unit to peel-off targeted adhesive seals from the seal template without contaminating a adhesive surface of the targeted seal being removed.

12. The method of claim 11, further comprising aligning the upper presser unit over the targeted adhesive seal and applying pressure to the upper presser unit to remove the targeted adhesive seal.

13. The method of claim 12, further comprising aligning the lower liner unit under the targeted adhesive seal and further in alignment with the upper pressure unit to provide a holding surface to prevent the targeted adhesive seal from being damage as pressure is applied to the upper presser unit to remove the targeted adhesive seal.

14. The method of claim 13, wherein the upper presser unit comprises a extraction hole for extracting the targeted adhesive seal from the seal template for affixing to the evacuation hole of the cover plate of the hard disk drive.

15. The method of claim 14, wherein the lower liner unit comprises a protrusion pin for holding an extracted adhesive sealing material from the seal template in place for extraction by the upper presser unit.
